(19) United States
(12) Patent Application Publication
(10) Pub. No.: US 2005/0056108 A1
(43) Pub. Date: Mar. 17, 2005

(54) Shifting device

(76) Inventors: Jorg Latuske, Golm (DE); Thomas Maier, Brandenburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/932,910

(22) Filed: Sep. 2, 2004

(30) Foreign Application Priority Data
Sep. 3, 2003 (DE) 103 40 474.0

(51) Int. Cl. B60K 20/00; F16H 59/00

(52) U.S. Cl. 74/473.1

(57) ABSTRACT

A shifting device for a manual shift transmission (8) of a vehicle (2) with a gear shift lever (20), which is secured in a holder (24) and is movably connected to a shifter-shaft (30) for the execution of axial displacements and rotational movements released by the gear shift lever (20), also the connection of the gear shift lever (20) with the shifter-shaft (30) is provided on that side of the shifter-shaft (30) which is positioned opposite to the supporting bearing (26) of the gear shift lever (20), for the purpose of achieving movements of the gear shift lever (20) and the shifter-shaft (30) which are in the same directional sense.

The invention concerns a shifting device in accord with the principal concept of claim 1.

For the shifting of manual transmissions of vehicles, hand operated gear change equipment is widely used.

Such a described shifting equipment, is known to the applicant from DE-A-199 01 056 as a generic type of manual shift. The gear shift lever is held in a first holder, which is anchored to the body of the vehicle. Within this first holder, the gear shift lever connects into a universal joint. By means of the universal joint bearing, the gear shift lever extends itself beyond the first holder, terminating as a sphere and engaging itself in a cylindrical retainer on a shifter-shaft, which is connected to the elements of the shifting arrangement. The now engaged bearing requires a choice of travel directional instructions, to be exercised by movement of the said gear shift lever. Thus, in the case of a forward movement of the gear shift lever, which initiates a shifting of gear stages in the manual transmission, the shifter-shaft is displaced to the rear, and vice versa. In the case of a gear shift lever movement transverse to the above, which again represents a change in gear stage selection, then a rotation of the said shifter-shaft is produced, whereby the direction of rotation of the shifter-shaft is made counter to the direction of movement of the gear shift lever. That is to say, if the gear shift lever is moved to the left, then the shifter-shaft will rotate to the right. This counter direction of motion is not favorable for the development of a manual transmission.

Thus the purpose of the invention, is to acquire a common directional sense of the gear shift lever and the shifter-shaft rotation upon the selection of a desired gear stage.

This purpose is achieved by a shifting device with the features of claim 1. Further embodiments are objects of subordinate claims.

In accord with the invention, a shifting device for a manual transmission of a vehicle includes a gear shift lever, which is retained in a first holder. The said holder is connected to the body of the vehicle and forms a universal joint for the gear shift lever. The gear shift lever is movably connected with a shifter-shaft for the execution of its axial and rotational movements as called for by the said gear shift lever. So that, in a case of a transverse motion of the gear shift lever, the shifter-shaft accordingly rotates in the correct direction, the connection of the gear shift lever to the shifter-shaft is placed on that side of the shifter-shaft in a second holder, which is opposite to the bearing of the gear shift lever in the said first holder. Thereby, a rotational reverse motion in the bearing is avoided.

In an advantageous embodiment, the connection between the gear shift lever and the shifter-shaft is provided by an apparatus, which bridges over both sides of the shifter-shaft, which apparatus is advantageously constructed in a ringlike or angular form.

In another advantageous embodiment, the connection between the gear shift lever and the shifter-shaft is by means of a yoke, with which the single open side of said yoke encompasses the shifter-shaft on only one side.

A particularly advantageous embodiment provides, that on the double-sided apparatus or the single-sided yoke, a come-along with a spherical projection is furnished, which engages itself in a cylindrical opening incised in the shifter-shaft.

The come-along, which is placed or on the shifter-shaft, or the said projection in the opening, which is to be found in the shifter-shaft, are advantageously present as releasable components, which are fastened onto the shifter-shaft.

The invention is described and explained in greater detail with the aid of a drawing. There is shown in:

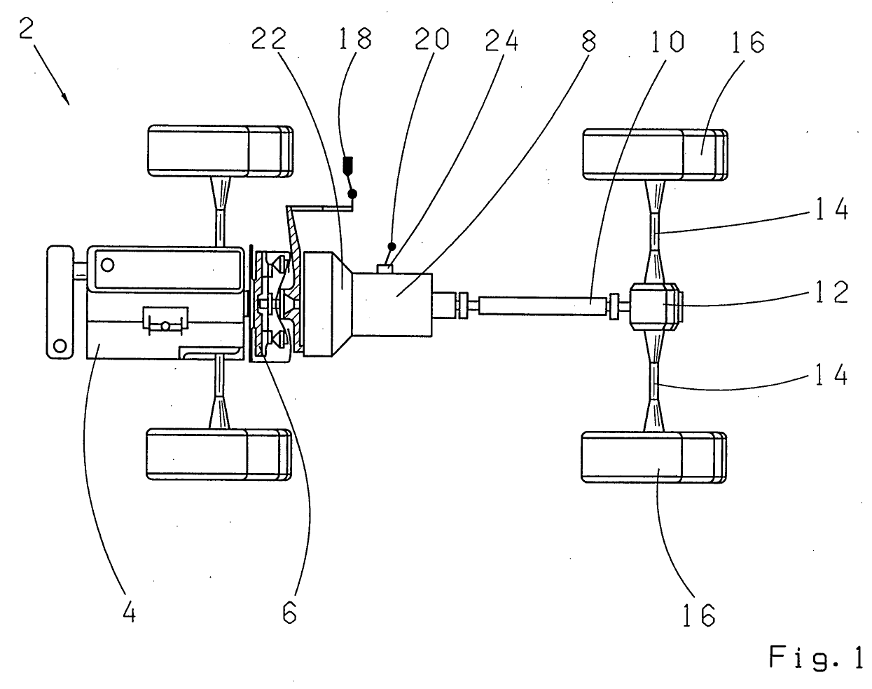

FIG. 1 a schematic diagram of a vehicle;

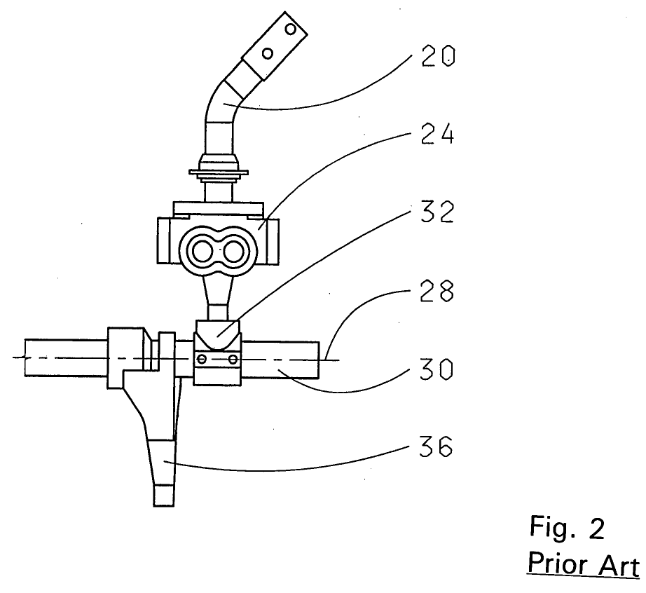

FIG. 2 gear shift lever with a shifter-shaft in accord with the state of the technology;

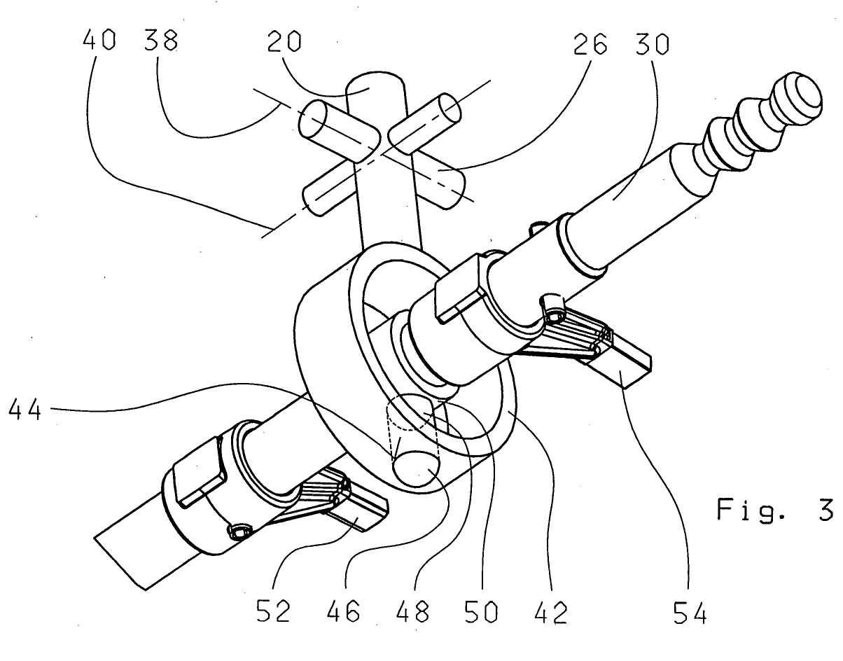

FIG. 3 a first connection of gear shift lever and shifter-shaft;

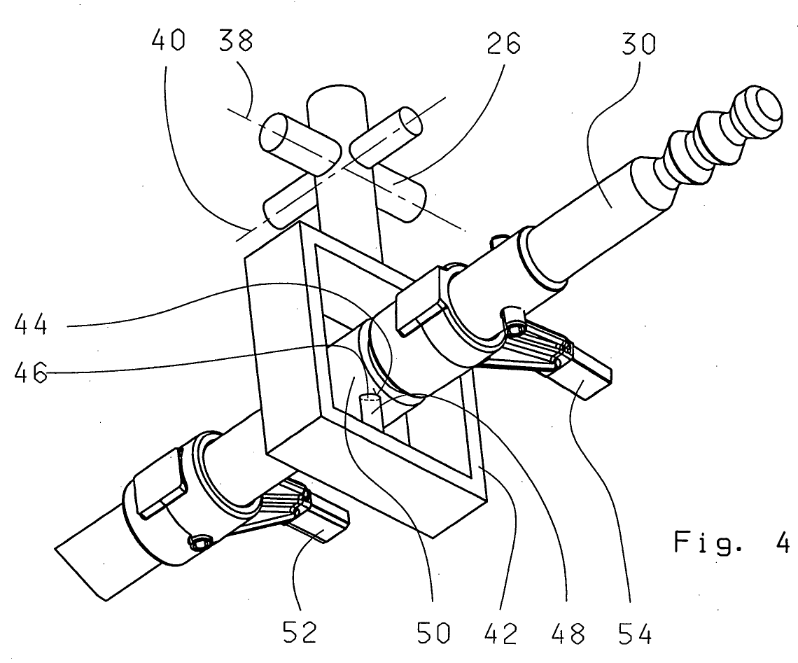

FIG. 4 a second connection of gear shift lever and shifter-shaft; and

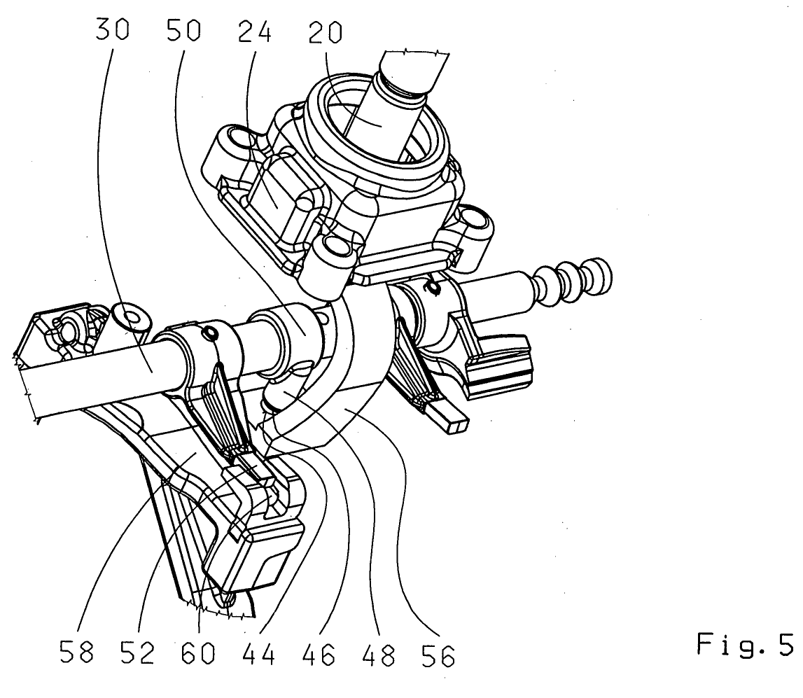

FIG. 5 a third connection of gear shift lever and shifter-shaft.

FIG. 1 shows a schematic presentation of the vehicle 2 with a driving motor 4, which, by means of a frictional clutch 6 acts upon a manual transmission 8. The manual transmission 8 is bound to a differential 12 by means of an output drive shaft 10, which respectively, drives the vehicle by the two semi-axles. The frictional clutch is subjected to a driver-actuated clutch pedal 18. The transmission 8 is acted upon by a manual gear shift lever 20, which is retained in a holder 24, which is secured to the housing 22 of the said transmission 8.

In FIG. 2 the said holder 24, known in the state of the technology, is illustrated in greater, descriptive detail. The gear shift lever 20 is borne in a universal joint (see FIG. 3) which is housed within the holder. This allows the said gear shift lever 20 to make forward and rearward movements, which cause a shifter-shaft 30 to be axially displaced along an imaginary axis 28. Likewise, the said gear shift lever 20 is enabled to make transverse movements, which lead to a rotation of the shifter-shaft 30 about an imaginary axis 28. In the shifter-shaft 30, is incised a cylindrical recess 32. Into this cylindrical opening 32, a spherical projection on the gear shift lever 20 engages itself. The spherical projection and the cylindrical opening 32 form a movable connection between the gear shift lever 20 and the shifter-shaft 30. On the shifter-shaft 30, in accord with the state of the technology, is fastened a shifting fork 36, which, upon an axial motion of the shifter-shaft 30, causes a shift into a desired gear stage in the manual transmission.

FIG. 3 shows a shifter-shaft 30 in accord with the invention in a perspective view from below. Integral with the gear shift lever 20, is to be easily seen the universal joint 26, whereby the gear shift lever 20, within the said holder (which is not shown here) can be moved about the axis 38 forward and backward and alternately, the gear shift lever can be likewise moved in a transverse direction about the axis 40.

On the under end of the gear shift lever 20 is to be found a apparatus 42, which, in this case, encompasses the shifter-shaft 30 on both sides with ample clearance. On that side of the shifter-shaft 30 which is opposite to the holder 24 and its enclosed universal joint 26, that is, graphically referring to FIG. 3, the apparatus 42 has an opening 44 underneath the shifter-shaft 30, into which a projection length 46 of a come-along 48 engages. The come-along 48 is in the form of a rod on a ring 50, which ring, by encirclement, is rotationally securely affixed to the shifter-shaft 30. The spherical projection 46 can then movably and complementarily engage itself in the opening 44.

A forward or backward displacement of the gear shift lever 20 along the longitudinal axis of the shifter-shaft 30, is converted by the above arrangement into a contrarily directed axial movement of the shifter-shaft 30 due to the positioning of the universal joint 26 and the therewith associated tipping movement of the gear shift lever 20 about the axis 38. If, however, the gear shift lever 20 is tipped in the universal joint 26 about the axis 40, then the apparatus 42 rotates itself about the shifter-shaft 30 in the same direction, and takes with it, along with the said opening 44 the come-along 46. The come-along 46, under this circumstance, then turns the shifter-shaft 30 by means of the ring 50 in the same direction as the tipping motion of the gear shift lever 20.

On the shifter-shaft 30 are placed, in this case, two shift fingers 52, 54, by which, upon the rotation of the shifter-shaft 30, a shifter fork, or a shift-rocker-arm (not shown) is respectively selected. This said fork or the like, can then perform a shifting operation, by an axial displacement of the shifter-shaft 30 along its longitudinal axis.

FIG. 4 shows an arrangement in accord with FIG. 3, wherein the apparatus 42, which encompasses the shifter-shaft 30, is substituted by an angular framing, also designated as 42. The come-along 48 is, in this case, fastened on the said framing 42 and engages with its spherical projection 46 into an opening 44, which is provided on the ring 50. This mode of functioning corresponds to the shifting apparatus of FIG. 3.

A further embodiment is to be seen in FIG. 5, wherein a yoke 56 replaces the said apparatus 42. In FIG. 5 is shown a perspective view from above, wherein the gear shift lever 20 which is carried in the holder 24, is connected with a yoke 56, which engages the shifter-shaft 30 only on one side. The come-along 48 is provided on the ring 50, which is again circularly fastened on the said shifter-shaft 30, which, with its spherical projection 46 fits into the opening 44 on the yoke 56. On the shifter fork 58, an opening 60 is so designed, that the shifting finger 52 can engage therein, at an appropriate positioning of shifter-shaft 30.

Reference Numerals

```
  2 vehicle
  4 drive motor
  6 friction clutch
  8 manual
10 transmission
12 output drive shaft
14 differential
16 semi axle
18 wheel of vehicle
20 clutch pedal
22 gear shift lever
24 housing
26 holder
28 universal joint
30 axis shift-shaft
32 opening
36 shifter fork
38 axis
40 axis
42 an apparatus
44 opening
46 projection
48 come-along
50 a ring
52 shift finger
54 shift finger
56 yoke
58 shifter fork
60 opening
```

1-8. (canceled)

9. A shifting device for a manual shift transmission (8) of a vehicle, having a gear shift lever (20), which is borne in a holder (24) and is movably connected with a shifter-shaft (30) for carrying out of axial displacements and rotary movements of the shifter-shaft (30) as released by the gear shift lever (20), a connection of the gear shift lever (20) to the shifter-shaft (30) is provided on a side of the shifter-shaft (30) oppositely situated to a bearing support (26) of the gear shift lever (20).

10. The shifting device according to claim 9, wherein the connection between the gear shift lever (20) and the shifter-shaft (30) is provided by an apparatus (42) which embraces the shifter-shaft (30) on two sides.

11. The shifting device according to claim 9, wherein an apparatus (42), which embraces the shifter-shaft (30) on two sides, is constructed to be circular in shape.

12. The shifting device according to claim 9, wherein an apparatus (42), which embraces the shifter-shaft (30) on two sides, is constructed to be angular in shape.

13. The shifting device according to claim 9, wherein the connection between the gear shift lever 20 and the shifter-shaft (30) is provided by a yoke (56) which embraces the shifter-shaft (30) on one side.

14. The shifting device according to claim 9, wherein on one of an embracing apparatus 42 or an embracing yoke (56), a cylindrical opening is provided, into which a spherical shaped projection (46) engages a come-along (48) affixed on the shifter-shaft (30).

15. The shifting device according to claim 9, wherein on one of an embracing apparatus (42) or an embracing yoke (56), a come-along (48) with a spherical projection (46) is provided, which engages in a cylindrical opening (44) in the shifter-shaft (30).

16. The shifting device according to claim 9, wherein a come-along (48) placed on one of the shifter-shaft (30) or an opening (44) located on the shifter-shaft (30) are provided in a releasably affixed component (50).
